(19) United States
(12) Patent Application Publication
(10) Pub. No.: US 2022/0406339 A1
(43) Pub. Date: Dec. 22, 2022

(54) VIDEO INFORMATION GENERATION METHOD, APPARATUS, AND SYSTEM AND STORAGE MEDIUM

(71) Applicant: Shenzhen Reolink Technology Co., Ltd., Shenzhen (CN)

(72) Inventors: Guixing WANG, Shenzhen (CN); Xiaoyu LIU, Shenzhen (CN); Xingyue GUO, Shenzhen (CN); Jiadong LI, Shenzhen (CN); Guobin LIN, Shenzhen (CN)

(21) Appl. No.: 17/528,156

(22) Filed: Nov. 16, 2021

(30) Foreign Application Priority Data
Jun. 17, 2021 (CN) 202110671711.1

(51) Int. Cl. G11B 27/19; G06V 20/40; G06V 10/62; G06T 7/246; G06V 10/74

(52) U.S. Cl. CPC G11B 27/19; G06V 20/41; G06V 10/62; G06T 7/246; G06V 10/761; G06T 2207/10016

(57) ABSTRACT

This application provides a video information generation method, apparatus, and system and a storage medium. The video information generation method includes: obtaining a plurality of temporally consecutive target images; obtaining first information of a target object in the target images; and associating first information of a same target object located in different target images to generate target information. In the video information generation method provided in this application, the first information of the target object in the target images is obtained, and the first information of the same target object located in different target images is associated. In this way, target information with a relatively small amount of data can be obtained, thereby improving the efficiency of remotely viewing a video by a user.

### CROSS-REFERENCE TO RELATED APPLICATIONS

The present application claims priority from the Chinese Invention Patent Application No. 202110671711.1 filed Jun. 17, 2021, and the disclosure of which is incorporated herein by reference in its entirety.

### FIELD OF THE INVENTION

This application relates to the field of image processing technologies, and specifically, to a video information generation method, apparatus, and system and a storage medium.

### BACKGROUND OF THE INVENTION

With the continuous work of a webcam and the increase in the capacity of a video storage device, it is easy to form a huge quantity of video files. However, most contents of the video files may not be of interests to the user, thus cause inconvenience to the user during video viewing. In particular, the time spent by the user and network bandwidth occupied are both largely wasted for viewing the video files remotely through a network.

### SUMMARY OF THE INVENTION

An objective of embodiments of this application is to provide a video information generation method, apparatus, and system and a storage medium, to improve the efficiency of remotely viewing a video by a user.

In a first aspect, the embodiments of this application provide a video information generation method, applicable to a webcam, the method including:

obtaining a plurality of temporally consecutive target images;

obtaining first information of a target object in the target images; and

associating first information of a same target object located in different target images to generate target information.

In a second aspect, the embodiments of this application provide a video information generation apparatus, including:

a first obtaining module, configured to obtain a plurality of temporally consecutive target images;

a second obtaining module, configured to obtain first information of a target object in the target images; and

a generation module, configured to associate first information of a same target object located in different target images to generate target information.

In a third aspect, the embodiments of this application provide a video information generation system, including:

a webcam, configured to obtain a plurality of temporally consecutive target images, obtain first information of a target object in the target images, and associate first information of a same target object located in different target images to generate target information; and

a user terminal, configured to display the target information.

In a fourth aspect, the embodiments of this application provide a readable storage medium. The readable storage medium stores a program or an instruction, the program or instruction, when executed by a processor, implementing steps in the video information generation method according to the first aspect.

In the technical solutions provided in the embodiments of this application, in the video information generation method, the first information of the target object in the target images is obtained, and the first information of the same target object located in different target images is associated. In this way, target information with a relatively small amount of data can be obtained, thereby improving the efficiency of remotely viewing a video (that is, a plurality of temporally consecutive target images) by a user.

### BRIEF DESCRIPTION OF THE DRAWINGS

FIG. 1 is a schematic flowchart of a video information generation method according to an embodiment of this application;

FIG. 2 is a schematic diagram of a track information display manner according to an embodiment of this application;

FIG. 3 is a schematic structural diagram of a video information generation apparatus according to an embodiment of this application;

FIG. 4 is a schematic structural diagram of another video information generation apparatus according to an embodiment of this application;

FIG. 5 is a schematic structural diagram of still another video information generation apparatus according to an embodiment of this application; and

FIG. 6 is a schematic structural diagram of a video information generation system according to an embodiment of this application.

### DETAILED DESCRIPTION

The technical solutions in the embodiments of this application are clearly and completely described below with reference to the accompanying drawings in the embodiments of this application. Apparently, the described embodiments are some rather than all of the embodiments of this application. All other embodiments obtained by a person of ordinary skill in the art based on the embodiments of this application without creative efforts shall fall within the protection scope of this application.

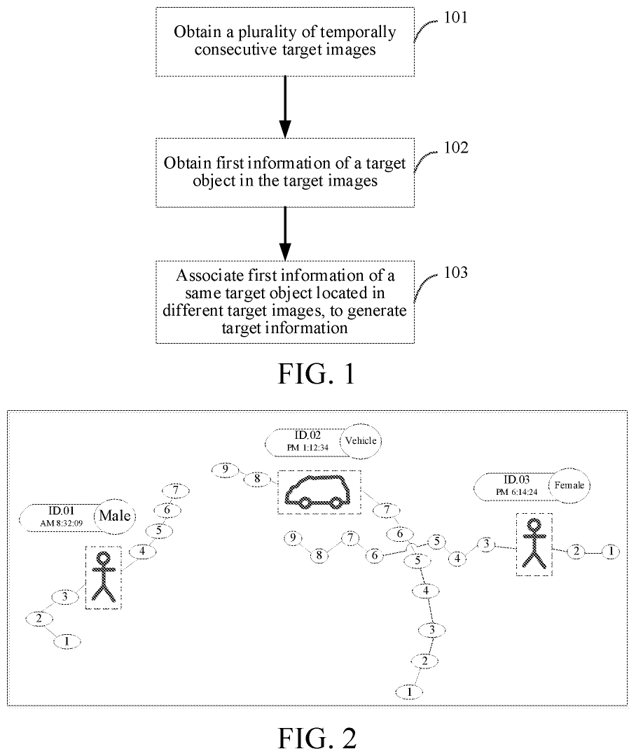

FIG. 1 is a schematic flowchart of a video information generation method according to an embodiment of this application. The video information generation method is applicable to a webcam. As shown in FIG. 1, the video information generation method includes the following steps:

Step 101. Obtain a plurality of temporally consecutive target images.

Step 102. Obtain first information of a target object in the target images.

Step 103. Associate first information of a same target object located in different target images to generate target information.

For example, a generation process of the target information may be:

There are two target images, which are target image No. 1 and target image No. 2 respectively.

The target image No. 1 includes first information a1 of a target object A and first information b1 of a target object B. The target image No. 2 includes first information a2 of the target object A and first information b2 of the target object B.

The first information a1 and the first information a2 are both first information of the target object A. Therefore, the first information a1 and the first information a2 are associated, and target information of the target object A can be obtained.

Similarly, the first information b1 and the first information b2 are associated, and target information of the target object B can be obtained.

In the video information generation method provided in the embodiments of this application, before a user remotely views the plurality of temporally consecutive target images, the plurality of target images can be processed in advance to obtain target information with a relatively small amount of data from the plurality of target images, and improve the efficiency of remotely viewing the plurality of target images by the user subsequently.

In practical applications, the target information may include a feature identifier (such as an image of the target object) and time information (such as a first appearing time when the target object appears firstly in the plurality of target images) of the target object, or may include a feature identifier overview of the target object (for example, text information such as “male in red” or “white vehicle”). In the process of remotely viewing the plurality of target images, the user may selectively obtain the target information of the plurality of target images. For example, the user may choose to download the feature identifier overview in the target information and not to download the feature identifier in the target information, so as to reduce time consumption of the user in a remote download process.

The target object is preferably a dynamic object in the target images, such as a person, a vehicle, or a pet.

As for a certain target image, there may be one or more target objects or no target object in the target image.

Optionally, the target information includes coordinate information and time information of the target object.

After the associating first information of a same target object located in different target images to generate target information, the method further includes:

obtaining, according to coordinate information and time information of at least one target object in the target information, first track information of the at least one target object, where the first track information is a motion track of the same target object in the plurality of target images; and

transmitting, if a first preset instruction issued by a user terminal is received, the first track information of the at least one target object to the user terminal.

For example, there are two target images, which are target image No. 3 and target image No. 4 respectively.

A time node corresponding to the target image No. 3 is the 1st second, and a time node corresponding to the target image No. 4 is the 2nd second. In addition, the target image No. 3 and the target image No. 4 both include a target object C. Coordinate information of the target object C in the target image No. 3 is (1,1), and coordinate information of the target object C in the target image No. 4 is (1,2).

Then, first track information of the target object C is a motion track of the target object C moving from the coordinate (1,1) to the coordinate (1,2) in a time period from the 1st second to the 2nd second.

Compared with a manner of displaying the target information only through text information (for example, the feature identifier overview mentioned above), a manner of displaying the target information in combination with the motion track of the target object can intuitively display motion of the target object in the plurality of target images to the user, to further improve the efficiency of remotely viewing a video by the user.

In practical applications, to fully display the motion track of the target object to the user, before the first track information is obtained, a target image may be further selected from the plurality of target images as a background image. Then, the first track information of the at least one target object is obtained according to the background image and the coordinate information and the time information of the at least one target object. The background image is preferably set as a target image not including the target object in the plurality of temporally consecutive target images.

Further, before the first track information of the at least one target object is obtained according to the background image and the coordinate information and the time information of the at least one target object, an example image of the at least one target object may be further obtained from the plurality of target images. Then, the first track information of the at least one target object is obtained according to the background image and the coordinate information, the time information, and the example image of the at least one target object. The example image is preferably set as an image with a highest image clarity score of the at least one target object in the plurality of target images.

It should be noted that, in practical applications, when the video information generation method is applied to a plurality of webcams associated with each other, the first track information may be adjusted adaptively to adapt to an association between the plurality of webcams. An example is provided for description:

There is a corridor, and the corridor includes three parts which are an entrance section, an intermediate section, and an exit section. Three mutually associated webcams are arranged in the corridor, and are respectively webcam No. 1 arranged at the entrance section of the corridor, webcam No. 2 arranged at the intermediate section of the corridor, and webcam No. 3 arranged at the exit section of the corridor.

When a target object D passes through the entrance section, the intermediate section, and the exit section in sequence, the plurality of temporally consecutive target images include some images captured by the webcam No. 1 when the target object D passes through the entrance section, some images captured by the webcam No. 2 when the target object D passes through the intermediate section, and some images captured by the webcam No. 3 when the target object D passes through the exit section. In this case, the background image can be obtained by splicing background image No. 1 (an image not including the target object) captured by the webcam No. 1, background image No. 2 captured by the webcam No. 2, and background image No. 3 captured by the webcam No. 3. First track information of the target object D is an entire motion track of the target object D passing through the corridor.

The user terminal may be a terminal side device such as a smartphone, a tablet personal computer, a laptop computer, a personal digital assistant (PDA), a mobile Internet device (MID), or a wearable device. It should be noted that, the specific type of the user terminal is not limited in the embodiments of this application. The user terminal can be communicatively connected to the webcams.

For example, a process of remotely viewing the plurality of target images by the user through the user terminal may be as follows: A mobile APP or a PC program is communicatively connected to the webcams storing the plurality of target images through a network. The target information stored in the webcams is transmitted to the mobile APP or the PC program to cause the user to quickly view the plurality of target images remotely.

Optionally, the at least one target object includes a first target object and a second target object.

After the obtaining, according to coordinate information and time information of at least one target object in the target information, first track information of the at least one target object, the method further includes:

combining first track information of the first target object and first track information of the second target object to obtain second track information; and

transmitting, if a second preset instruction issued by the user terminal is received, the second track information to the user terminal.

As described above, in a case that there are two or more target objects in the plurality of target images, second track information can be obtained by combining first track information of the two or more target objects, to further improve the efficiency of remotely viewing the plurality of target images by the user.

For example, it is supposed that a time span of the plurality of target images is 15 minutes, and the plurality of target images include a target object E1, a target object E2, and a target object E3.

The target object E1 appears in a time period from the 0th minute to the 5th minute. The target object E2 appears in a time period from the 5th minute to the 10th minute. The target object E3 appears in a time period from the 10th minute to the 15th minute.

In this case, motion tracks of different target objects appearing in different time periods can be superimposed and displayed through the foregoing combination operation. That is, in a same background image, a motion track of the target object E1, a motion track of the target object E2, and a motion track of the target object E3 are superimposed and displayed. Compared with a manner of viewing first track information respectively corresponding to different target objects one by one, the foregoing manner can make it convenient for the user to view the motion track of the target object, further improving the efficiency of remotely viewing a video by the user.

FIG. 2 is a schematic diagram of a track information display manner according to an embodiment of this application, where the second track information displayed by the user terminal is shown. As shown in FIG. 2, the second track information involves three different target objects, which are respectively target object No. 1, target object No. 2, and target object No. 3.

The target object No. 1 is a male, and has a first appearing time at AM 8:32:09 in in the plurality of target images. The target object No. 2 is a vehicle, and has a first appearing time at PM 1:12:35 in the plurality of target images. The target object No. 3 is a female, and has a first appearing time at PM 6:14:24 in the plurality of target images.

In practical applications, apart from the line connection manner shown in FIG. 2, different motion tracks of different target objects in the same background image may alternatively be distinguished through color identification. The embodiments of this application impose no limitation on the specific display manner of the first track information and the second track information.

Optionally, after the associating first information of a same target object located in different target images to generate target information, the method further includes:

obtaining, according to the time information of the at least one target object, a first appearing time when the same target object appears firstly in the plurality of target images; and

transmitting, if a third preset instruction issued by the user terminal is received, the first appearing time to the user terminal to cause the user terminal to play the plurality of target images using the first appearing time as start play time.

Through the foregoing setting, the efficiency of remotely viewing a video by the user can be further improved.

For example, if the time span of the plurality of target images is 10 seconds, and the first appearing time when the target object appears firstly in the plurality of target images is at the 3rd second, the plurality of target images will be played from the 3rd second after the user terminal obtains the first appearing time and the plurality of target images.

In practical applications, the third preset instruction may be a key instruction issued by the user through the mobile APP or the PC program. That is, after determining a target object in which the user is interested according to the first track information or the second track information, the user plays the plurality of target images including the target object by means of clicking a mouse/tapping touch screen. In addition, the start play time of the plurality of target images is the first appearing time when the target object appears firstly in the plurality of target images. The embodiments of this application impose no limitation on the specific implementation form of the first preset instruction or the second preset instruction or the third preset instruction.

Optionally, the target information includes a feature identifier of the target object; and

the obtaining first information of a target object in the target images includes:

performing feature extraction on the target images to obtain the feature identifier and the coordinate information of the target object in the target images;

obtaining time nodes of the target images; and

obtaining the first information of the target object in the target images according to the feature identifier, the coordinate information, and the time nodes.

For example, a process of obtaining the feature identifier of the target object in the target images may be:

traversing the plurality of target images;

performing primary feature extraction on each target image using a convolutional neural network to obtain an original feature of the target object in the target images; and

performing secondary feature extraction on the original feature using a person re-identification algorithm to obtain the feature identifier of the target object in the target images.

It should be noted that, the convolutional neural network is preferably an hourglass network, and the person re-identification algorithm is preferably a person re-identification algorithm with an Embedding branch.

A data processing process of the hourglass network may be:

by introducing a deformable convolution kernel and a dilated convolution kernel, performing convolution and pooling on each target image to obtain first feature information of the target image; and

performing up-sampling and skip connection on the first feature information to obtain the original feature of the target object in the target images.

Compared with using a VGG network or a ResNet network, using the hourglass network can reduce the feature missing probability of the original feature of the target object. An objective of introducing the deformable convolution kernel and the dilated convolution kernel is to improve the receptive field and detection accuracy of the hourglass network for the target images. As for using the person re-identification algorithm with the Embedding branch, different feature identifiers of different target objects in the target images can have a relatively good discrimination.

In addition, for the same target object, the time information of the target object can be obtained according to a plurality of time nodes of the plurality of target images including the target object.

For example, there are four target images, which are target image No. 5, target image No. 6, target image No. 7, and target image No. 8 respectively.

A time node corresponding to the target image No. 5 is the 1st second, a time node corresponding to the target image No. 6 is the 2nd second, a time node corresponding to the target image No. 7 is the 3rd second, and a time node corresponding to the target image No. 8 is the 4th second. The target image No. 5, the target image No. 6, and the target image No. 7 all include a target object F. The target image No. 8 does not include the target object F.

Then, time information of the target object F includes the 1st second, the 2nd second, and the 3rd second. The 1st second is first appearing time when the target object F appears firstly in the four target images.

Optionally, the associating first information of a same target object located in different target images to generate target information includes:

determining, according to a similarity between a feature identifier of a third target object in a first target image and a feature identifier of a fourth target object in a second target image, whether the third target object and the fourth target object are a same target object; and

associating, if the third target object and the fourth target object are a same target object, first information of the third target object and first information of the fourth target object to generate the target information.

Preferably, the first information of the same target object located in different target images is associated through a Kuhn-Munkres (KM) linear assignment algorithm. In practical applications, the first information of the same target object located in different target images may alternatively be associated using a Hungarian algorithm. A similarity between the feature identifiers of the target object in the target images may be calculated using a Pearson correlation algorithm. The embodiments of this application impose no limitation on the specific algorithm of associating or matching different first information of the same target object in different target images.

Optionally, before the obtaining first information of a target object in the target images, the method further includes:

grouping the plurality of target images to obtain a plurality of groups of temporally consecutive target images, where each group of target images includes a same quantity of target images; and

sampling each group of target images to obtain a plurality of sample images; and

the obtaining first information of a target object in the target images includes:

obtaining, for each sample image in the plurality of sample images, first information of a target object in the sample image.

Through the foregoing setting, the data processing volume is reduced, and the efficiency of obtaining the target information is improved.

For example, it is supposed that the time span of the plurality of target images is 3 seconds, 9 target images are included in every one second, and the plurality of target images are divided into 3 groups, where a first group of target images is the 9 target images in the 1st second, a second group of target images is the 9 target images in the 2nd second, and a third group of target images is the 9 target images in the 3rd second.

The fifth target image in each group of target images is selected as a sample target image. Then, the plurality of sample target images are the fifth target image in the 1st second, the fifth target image in the 2nd second, and the fifth target image in the 3rd second.

Compared with processing all the target images in the plurality of target images one by one, the foregoing sampling manner can effectively reduce the quantity of target images to be processed and improve the efficiency of obtaining the target information. In practical applications, the foregoing grouping rule and sampling rule may be adjusted based on practical needs. For example, a plurality of target images included in the plurality of target images within 0.5 seconds are selected as a group of target images, or each group of target images is sampled in an interval sampling manner (that is, a plurality of sample target images are selected from a group of target images, and two adjacent sample target images are separated by a same quantity of target images). The embodiments of this application impose no limitation on the specific grouping rule and sampling rule.

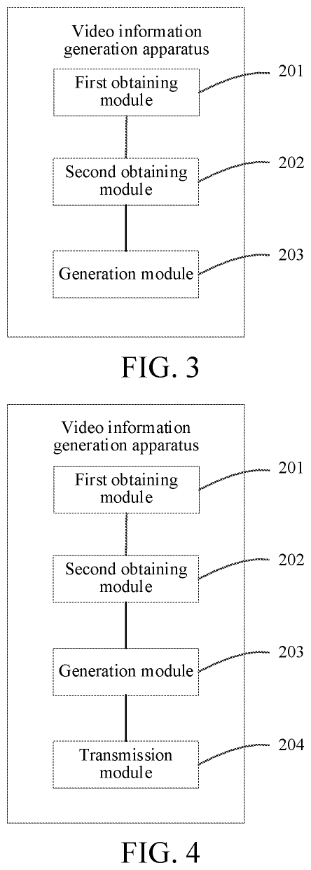

FIG. 3 shows a video information generation apparatus according to an embodiment of this application. The apparatus includes:

a first obtaining module 201, configured to obtain a plurality of temporally consecutive target images;

a second obtaining module 202, configured to obtain first information of a target object in the target images; and

a generation module 203, configured to associate first information of a same target object located in different target images to generate target information.

Optionally, as shown in FIG. 4, the target information includes coordinate information and time information of the target object; and the generation module 203 is further configured to:

obtain, according to coordinate information and time information of at least one target object in the target information, first track information of the at least one target object, where the first track information is a motion track of the same target object in the plurality of target images; and

the apparatus further includes a transmission module 204, and the transmission module 204 is configured to transmit, when a first preset instruction issued by a user terminal is received, the first track information of the at least one target object to the user terminal.

Optionally, the at least one target object includes a first target object and a second target object, and the generation module 203 is further configured to:

combine first track information of the first target object and first track information of the second target object to obtain second track information; and

the transmission module 204 is further configured to transmit, when a second preset instruction issued by the user terminal is received, the second track information to the user terminal.

Optionally, the generation module 203 is further configured to:

obtain, according to the time information of the at least one target object, a first appearing time when the same target object appears firstly in the plurality of target images;

and

the transmission module 204 is further configured to transmit, when a third preset instruction issued by the user terminal is received, the first appearing time to the user terminal to cause the user terminal to play the plurality of target images using the first appearing time as start play time.

Optionally, the target information includes a feature identifier of the target object, and the second obtaining module 202 is configured to:

perform feature extraction on the target images to obtain the feature identifier and the coordinate information of the target object in the target images;

obtain time nodes of the target images; and

obtain the first information of the target object in the target images according to the feature identifier, the coordinate information, and the time nodes.

Optionally, the generation module 203 is configured to:

determine, according to a similarity between a feature identifier of a third target object in a first target image and a feature identifier of a fourth target object in a second target image, whether the third target object and the fourth target object are a same target object; and

associate, if the third target object and the fourth target object are a same target object, first information of the third target object and first information of the fourth target object to generate the target information.

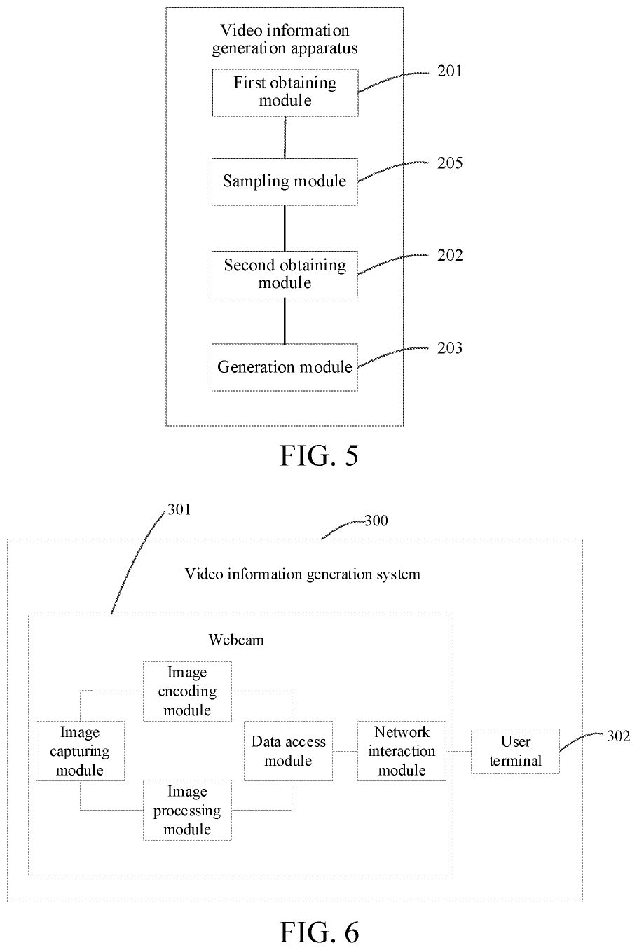

Optionally, as shown in FIG. 5, the apparatus further includes a sampling module 205, and the sampling module 205 is configured to:

group the plurality of target images to obtain a plurality of groups of temporally consecutive target images, where each group of target images includes a same quantity of target images; and

sample each group of target images to obtain a plurality of sample images; and

the second obtaining module 202 is configured to obtain, for each sample image in the plurality of sample images, first information of a target object in the sample image.

FIG. 6 is a schematic structural diagram of a video information generation system 300 according to an embodiment of this application. As shown in FIG. 6, the video information generation system 300 includes:

a webcam 301, configured to obtain a plurality of temporally consecutive target images, obtain first information of a target object in the target images, and associate first information of a same target object located in different target images to generate target information; and

a user terminal 302, configured to display the target information.

As shown in FIG. 6, in practical applications, the webcam 301 may include an image capturing module, an image encoding module, an image processing module, a data access module, and a network interaction module.

The image capturing module is configured to obtain the plurality of temporally consecutive target images, and transmit the plurality of target images to each of the image encoding module and the image processing module.

The image encoding module is configured to encode the plurality of target images to generate video data required for video recording, and transmit the video data to the data access module.

The image processing module is configured to obtain the first information of the target object in the target images; associate the first information of the same target object located in different target images to generate the target information; and transmit the target information to the data access module.

The data access module is configured to receive and store the video data and the target information, and transmit the video data and/or the target information to the network interaction module.

The network interaction module is configured to transmit the video data and/or the target information to the user terminal according to an instruction transmitted by the user terminal.

It should be noted that, apart from transmitting the target information to the user terminal, the image processing module, the data access module, and the network interaction module can further cooperate with each other to perform procedures in the foregoing video information generation method embodiment, and can achieve the same technical effects. To avoid repetition, detailed descriptions are not provided herein again.

The embodiments of this application further provide a readable storage medium. The readable storage medium stores a program or an instruction. The program or instruction, when executed by a processor, implements the procedures in the foregoing video information generation method embodiment, and can achieve the same technical effects. To avoid repetition, detailed descriptions are not provided herein again.

Through the descriptions of the foregoing implementations, a person skilled in the art may clearly understand that the method according to the foregoing embodiments may be implemented by means of software and a necessary general hardware platform, and certainly, may alternatively be implemented by hardware, but in many cases, the former manner is a better implementation. Based on such an understanding, the technical solutions of this application essentially or the part contributing to the related art may be implemented in the form of a software product. The computer software product is stored in a storage medium (such as a read-only memory (ROM)/random access memory (RAM), a magnetic disk, or an optical disc), and includes several instructions for instructing a terminal (which may be a mobile phone, a computer, a server, an air conditioner, a network device, or the like) to perform the method described in the embodiments of this application.

The embodiments of this application are described above with reference to the accompanying drawings. However, this application is not limited to the foregoing specific implementations. The foregoing specific implementations are merely illustrative, but not restrictive. Under the enlightenment of this application, a person of ordinary skill in the art can make many forms without departing from the purpose of this application and the scope protected by the claims, and all of the forms fall within the protection of this application.

What is claimed is:

1. A video information generation method, applicable to a webcam, the method comprising:
obtaining a plurality of temporally consecutive target images;
obtaining first information of a target object in the target images, wherein the first information comprises time nodes of the target images; and
associating first information of a same target object located in different target images to generate target information, wherein the target information comprises coordinate information and time information of the same target object, and the information of the same target object is generated by associating time nodes of target images including the same target object;
obtaining, according to the coordinate information and the time information of at least one target object in the target information, first track information of the at least one target object, wherein the first track information is a motion track of the same target object in the plurality of target images;
transmitting, if a first preset instruction issued by a user terminal is received, the first track information of the at least one target object to the user terminal;
obtaining, according to the time information of the at least one target object, a first appearing time when the same target object appears firstly in the plurality of target images; and
transmitting, if a third preset instruction issued by the user terminal is received, the first appearing time to the user terminal to cause the user terminal to play the plurality of target images using the first appearing time as start play time.

2. (canceled)

3. The method according to claim 1, wherein:
the at least one target object comprises a first target object and a second target object; and
after the obtaining, according to coordinate information and time information of at least one target object in the target information, first track information of the at least one target object, the method further comprises:
combining first track information of the first target object and first track information of the second target object to obtain second track information; and
transmitting, if a second preset instruction issued by the user terminal is received, the second track information to the user terminal.

4. (canceled)

5. The method according to claim 1, wherein:
the target information comprises a feature identifier of the target object; and
the obtaining first information of a target object in the target images comprises:
performing feature extraction on the target images to obtain the feature identifier and the coordinate information of the target object in the target images;
and
obtaining the first information of the target object in the target images according to the feature identifier, the coordinate information.

6. The method according to claim 5, wherein the associating first information of a same target object located in different target images to generate target information comprises:
determining, according to a similarity between a feature identifier of a third target object in a first target image and a feature identifier of a fourth target object in a second target image, whether the third target object and the fourth target object are a same target object; and
associating, if the third target object and the fourth target object are a same target object, first information of the third target object and first information of the fourth target object to generate the target information.

7. The method according to claim 1, before the obtaining first information of a target object in the target images the method further comprises:
grouping the plurality of target images to obtain a plurality of groups of temporally consecutive target images, wherein each group of target images comprises a same quantity of target images; and
sampling each group of target images to obtain a plurality of sample images; and
the obtaining first information of a target object in the target images comprises obtaining, for each sample image in the plurality of sample images, first information of a target object in the sample image.

8. A video information generation apparatus, comprising:
a first obtaining module, configured to obtain a plurality of temporally consecutive target images;
a second obtaining module, configured to obtain first information of a target object in the target images, wherein the first information comprises time nodes of the target images;
a generation module, configured to:
associate first information of a same target object located in different target images to generate target information, wherein the target information comprises coordinate information and time information of the same target object, and the time information of the same target object is generated by associating time nodes of target images including the same target object;
obtain, according to the coordinate information and the time information of at least one target object in the target information, first track information of the at least one target object, wherein the first track information is a motion track of the same target object in the plurality of target images; and
obtain, according to the time information of the at least one target object, a first appearing time when the same target object appears firstly in the plurality of target images, and
a transmission module, configured to:
transmit, when a first preset instruction issued by a user terminal is received, the first track information of the at least one target object to the user terminal; and
transmit, when a third preset instruction issued by the user terminal is received, the first appearing time to the user terminal to cause the user terminal to play the plurality of target images using the first appearing time as start play time.

9. (canceled)

10. The apparatus according to claim 8, wherein:
the at least one target object comprises a first target object and a second target object;
the generation module is further configured to combine first track information of the first target object and first track information of the second target object to obtain second track information; and
the transmission module is further configured to transmit, when a second preset instruction issued by the user terminal is received, the second track information to the user terminal.

11. (canceled)

12. The apparatus according to claim 8, wherein:
the target information comprises a feature identifier of the target object;
the second obtaining module is configured to:
perform feature extraction on the target images to obtain the feature identifier and the coordinate information of the target object in the target images;
and
obtain the first information of the target object in the target images according to the feature identifier and the coordinate information.

13. The apparatus according to claim 12, wherein the generation module is configured to:
determine, according to a similarity between a feature identifier of a third target object in a first target image and a feature identifier of a fourth target object in a second target image, whether the third target object and the fourth target object are a same target object; and
associate, if the third target object and the fourth target object are a same target object, first information of the third target object and first information of the fourth target object to generate the target information.

14. The apparatus according to claim 8, wherein
the apparatus further comprises a sampling module configured to:
group the plurality of target images to obtain a plurality of groups of temporally consecutive target images, wherein each group of target images comprises a same quantity of target images; and
sample each group of target images to obtain a plurality of sample images; and
the second obtaining module is configured to obtain, for each sample image in the plurality of sample images, first information of a target object in the sample image.

15. (canceled)

16. A non-transitory computer-readable storage medium, storing a program or an instruction, the program or instruction, when executed by a processor, implementing a video information generation method applicable to a webcam, the method comprising:
obtaining a plurality of temporally consecutive target images;
obtaining first information of a target object in the target images, wherein the first information comprises time nodes of the target images; and
associating first information of a same target object located in different target images to generate target information, wherein the target information comprises coordinate information and time information of the same target object, and the time information of the same target object is generated by associating time nodes of target images including the same target object;
obtaining, according to the coordinate information and the time information of at least one target object in the target information, first track information of the at least one target object, wherein the first track information is a motion track of the same target object in the plurality of target images;
transmitting, if a first preset instruction issued by a user terminal is received, the first track information of the at least one target object to the user terminal;
obtaining, according to the time information of the at least one target object, a first appearing time when the same target object appears firstly in the plurality of target images; and
transmitting, if a third preset instruction issued by the user terminal is received, the first appearing time to the user terminal to cause the user terminal to play the plurality of target images using the first appearing time as start play time.

17. (canceled)

18. The non-transitory computer-readable storage medium according to claim 16, wherein:
the at least one target object comprises a first target object and a second target object; and
after the obtaining, according to coordinate information and time information of at least one target object in the target information, first track information of the at least one target object, the method further comprises:
combining first track information of the first target object and first track information of the second target object to obtain second track information; and
transmitting, if a second preset instruction issued by the user terminal is received, the second track information to the user terminal.

19. (canceled)

20. The non-transitory computer-readable storage medium according to claim 16, wherein:
the target information comprises a feature identifier of the target object; and
the obtaining first information of a target object in the target images comprises:
performing feature extraction on the target images to obtain the feature identifier and the coordinate information of the target object in the target images;
and
obtaining the first information of the target object in the target images according to the feature identifier and the coordinate information.

21. The non-transitory computer-readable storage medium according to claim 20, wherein the associating first information of a same target object located in different target images to generate target information comprises:
determining, according to a similarity between a feature identifier of a third target object in a first target image and a feature identifier of a fourth target object in a second target image, whether the third target object and the fourth target object are a same target object; and
associating, if the third target object and the fourth target object are a same target object, first information of the third target object and first information of the fourth target object to generate the target information.

22. The non-transitory computer-readable storage medium according to claim 16, before the obtaining first information of a target object in the target images the method further comprises:
grouping the plurality of target images to obtain a plurality of groups of temporally consecutive target images, wherein each group of target images comprises a same quantity of target images; and
sampling each group of target images to obtain a plurality of sample images; and
the obtaining first information of a target object in the target images comprises obtaining, for each sample image in the plurality of sample images, first information of a target object in the sample image.
